(19) United States
(12) Patent Application Publication
(10) Pub. No.: US 2003/0120538 A1
(43) Pub. Date: Jun. 26, 2003

(54) Method of tracking progress on a task

(76) Inventors: Scott R. Boerke, Morton, IL (US); William E. Harmon JR., Delavan, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/027,717

(22) Filed: Dec. 20, 2001

(51) Int. Cl. G06F 17/60

(52) U.S. Cl. 705/11; 705/9

(57) ABSTRACT

A method tracks progress, by at least one worker, on a task over a predetermined period of time. The task includes a plurality of subtasks. The method includes the steps of dividing the period of time into a plurality of timeslots and determining a target number of subtasks to be completed during each timeslot. The method further includes the steps of tracking an actual number of subtasks completed by each worker in each time slot, recording a variance between the actual number of subtasks completed and the target number in each time slot, and recording an accumulated variance in each time slot. Further, the method includes the steps of recording a total variance for the predetermined period of time without reference to the workers.

### TECHNICAL FIELD

The present invention relates generally to a method for tracking progress on a task, and more particularly, to a method for tracking progress on a task by a plurality of workers.

### BACKGROUND

Many types of jobs and tasks are composed of similar or repetitive subtasks. From an efficiency or process improvement perspective, such types of tasks present several challenges.

For example, the worker or person performing the task may experience a lack of motivation due to the repetitive nature of the work. Additionally, any attempts to analyze the process may fail due to a lack of understanding the reasons for not achieving a specific goal.

Prior attempts to track the progress efficiency of performing such tasks have involved dividing a period of time, such as a shift, into time slots, e.g. fifteen (15) minutes and setting a goal of a number of tasks completed for each worker for each slot. This information is then recorded and used as part of a performance evaluation for each worker. However, such a process focuses on the individual's performance or failure to perform and not on the underlying issues which may causing the resultant failure to perform.

Additionally, any attempts to improve the processes involved in performing the tasks or removing any obstacles in completing the tasks would require actual data. Prior attempts at tracking performance focus on employee performance and/or track performance by employee. This has a tendency to reduce the accuracy of the data.

The present invention is aimed at overcoming one or more of the problems set forth above.

### SUMMARY OF THE INVENTION

In one aspect of the present invention, a method for tracking progress, by at least one worker, on a task over a predetermined period of time, is provided. The task includes a plurality of subtasks. The method includes the steps of dividing the period of time into a plurality of timeslots and determining a target number of subtasks to be completed during each timeslot. The method further includes the steps of tracking an actual number of subtasks completed by at least one worker associated with each time slot, and recording a variance between the actual number of subtasks completed and the target number associated with each time slot, and recording an accumulated variance associated with each time slot.

In another aspect of the present invention, a method for tracking progress, by at least one worker, on a task over a predetermined period of time, is provided. The task includes a plurality of sub-subtasks. The method includes the steps of dividing the period of time into a plurality of timeslots, determining a target number of subtasks to be completed during each timeslot, and tracking an actual number of subtasks completed by at least one worker in each time slot. The method further includes the steps of recording a variance between the actual number of subtasks completed and the target number associated with each time slot, recording an accumulated variance associated with each time slot, and recording a total variance for the predetermined period of. The method also includes the steps of providing a variance card to the at least one employee, recording a reason on the variance card for any variance between the actual number of subtasks completed and the target number, and recording a total variance for the predetermined period of time and the reason for any variance. In addition, the method includes the step of modifying the target number of subtasks to be completed during each time slot as a function of the total variance and the reason.

### BRIEF DESCRIPTION OF THE DRAWINGS

FIG. 1 is flow diagram of a process for tracking progress on a task, according to an embodiment of the present invention;

FIG. 2 is a flow diagram of a process for tracking progress on a task, according to another embodiment of the present invention;

FIG. 3A is a sample variance report illustrating the number of variance over a period of time, according to an embodiment of the present invention;

FIG. 3B is a sample variance chart in the form of a pie chart illustrating the recorded reasons for variances over a period of time, according to an embodiment of the present invention;

FIG. 4 is a diagrammatic illustration of a writeable medium for recording progress on a task, according to an embodiment of the present invention;

FIG. 5 is a diagrammatic illustration of a first example of a variance card, according to an embodiment of the present invention;

FIG. 6 is a diagrammatic illustration of a second example of a variance card, according to an embodiment of the present invention;

FIG. 7 is a diagrammatic illustration of a third sample of a variance card, according to an embodiment of the present invention; and,

FIG. 8 is a diagrammatic illustration of a fourth example of a variance card, according to an embodiment of the present invention;

FIG. 9 is a diagrammatic illustration of a fifth example of a variance card, according to an embodiment of the present invention; and,

FIG. 10 is a diagrammatic illustration of a sixth example of a variance card, according to an embodiment of the present invention.

### DETAILED DESCRIPTION

With reference to the drawings and in operation, the present method provides a method for tracking progress, by at least one worker, on a task over a period of time. The task includes a plurality of subtasks or “tracks”.

In one embodiment, the period of time is predetermined. In another embodiment, the period of time is not set. For example, the period of time may be a work shift for the workers performing the task. In another embodiment, the period of time is dependent upon the amount of work to be done to accomplish a task, e.g., ½ or ¾ of a work shift.

The task may include any type of work. For example, in one embodiment the task is filling orders. Each order may be considered a subtask. Generally, filling the order would include (1) reading the order and (2) retrieving the items listed on the order.

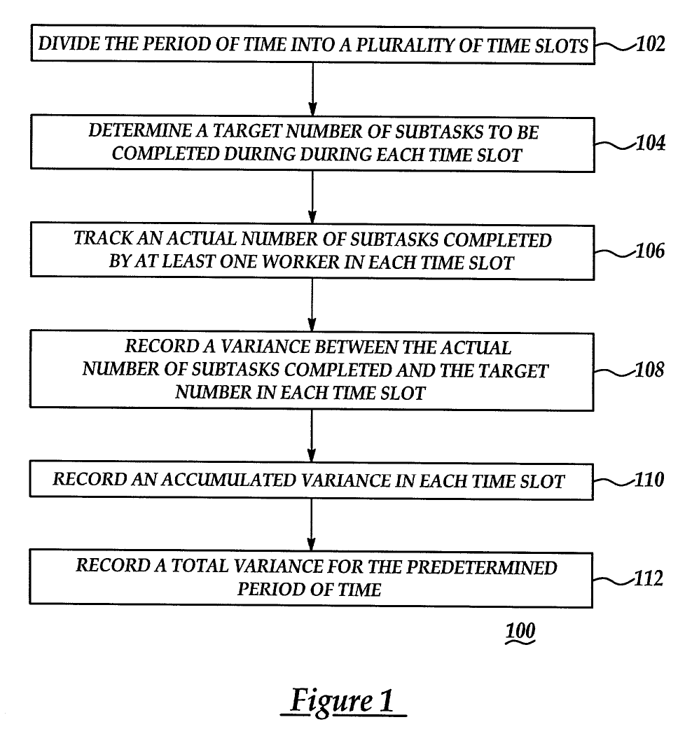

With specific reference to FIG. 1, a process or method 100 for tracking progress on a task according to a first embodiment of the present invention will now be discussed. In a first process block 102, the period of time is divided into a plurality of time slots. In one embodiment, the time slots are of the same length, e.g., one (1) hour. For example, if the predetermined period of time is a work shift, generally eight (8) hours, and the time slots are one (1) hour, there would be 8 time slots in the predetermined time period.

The process 100 further includes the step (second process block 104) of determining a target number of subtasks to be completed during each timeslot. In one embodiment, the target number of subtasks to be completed during each timeslot is not necessarily the same for each time slot. For example, the target number of subtasks may be determined as a function of regularly schedule meetings or work breaks.

In a third process block 106, an actual number of subtasks completed by at least one worker in each time slot is tracked.

In a fourth process block 108, a variance between the actual number of subtasks completed and the target number in each time slot is tracked.

In a fifth process block 110, an accumulated variance in each time slot is recorded. In a sixth process block 112, a total variance is recorded for the period of time. It should be noted that recordation of the accumulated variance and total variance is for informational purposes only and need not be recorded on the optional.

With specific reference to FIG. 4, the progress of the workers on the task is tracked on a writeable medium 400, shown as a “TRACKS Process Board”. In one embodiment, the TRACKS Process Board or board 400 is posted nearby the workers. The board 400 may be a sheet of paper, a poster, or an erasable medium, such as a chalk board or a white board. The grid and other information (see below) are pre-printed on the board 400 (see below). The workers are encouraged to record their progress on the task on the Board 400. In one embodiment, the workers are required to record their progress on the task.

In an alternative embodiment, the board 400 is represented on a computer screen (not shown) of a computer (not shown) and input onto the board 400 is input into the computer using conventional means, such as a keyboard and/or mouse.

In one embodiment, the board 400 includes an information section 402, a grid section 404, and a day information section 406. The information section 402 is used for planning purposes and provides information regarding, for example, how many subtasks or tracks are available. Using this information, a supervisor may determine how many work-hours are required to complete the task and thus how many employees are required.

The process 100 may be used for planning purposes, i.e., as a planning tool. Work flow is broken down into consistent time increments (time slots). Each function that needs to be accomplished on a given day may be broken down in to specified time increments. A task force, i.e., a group of workers, may be assigned to the work flow based on the number of tracks in the work flow. Therefore, at the beginning of the day, the number of workers may be identified that will be needed for the day's work in a specific area. If a work area normally has work for eight (8) people and today, the plan, i.e., track allocations, indicate only 7½ workers are needed, then arrangements may be made to have one worker work in another area for ½ a shift. The other area to be worked is understaffed by at least ½ worker. Therefore, reallocating the work force in response to the number of people as identified by the present invention enables a more efficient work force and distribution of the work force.

The grid section 404 is used to record information regarding the planned progress towards the task and the actual progress (see below).

The day information section 406 is used to indicate the day of the week.

In one embodiment, the information on the board 400 is recorded over the predetermined period of time. In a first embodiment, after the predetermined period of time has ended, only the total variance (see below) is recorded. In one embodiment, this information is recorded without reference to any worker's individual performance. In a second embodiment, other information could be recorded, such as the variance for each time slot or all the information recorded on the board 400.

Thereafter, the board 400 is discarded or the information recorded thereon is erased.

The grid section 404 is divided into a number of columns, a period column 408, a number of tracks column 410, a planned column 412, an actual column 414, a variance column 416, a plurality of employee or worker columns 418, and a comments column 420.

As shown on the exemplary board 400 of FIG. 4, the predetermined period of time covers eight (8) hours of a nine (9) hour period. The predetermined period of time is divided into one (1) hour time slots, 7-8, 8-9, 9-10, 10-11, 11-12, 1-2, 2-3, and 3-4, which are recorded in the period column 408. For this particular task, the one hour time slots have been assigned 3, 4, 3, 4, 4, 4, 3, and 3 tracks or subtasks (per each employee), respectively. The number of tracks are recorded in the number of tracks column 410. As mentioned, the variations may be due to meetings, breaks or the manner in which the sub-tasks are likely to be completed.

In the illustrated embodiment, there are three employees. Thus the number of planned tracks for each time slot as well as the planned accumulated tracks for each time slot are recorded in the planned column. For example, in the 7-8 time slot there are three (3) planned tracks for each worker. Thus, the total planned tracks for the 7-8 time slot is 9. Since this is the first time slot, the planned accumulated tracks is also 9. In the second time slot 8-9, there are 4 tracks for worker. Thus, there are 12 planned tracks for the time slot and the accumulated planned tracks are 21 (9+12).

In one embodiment, at least once every time slot (every hour), the workers are encouraged to go to the board 400 and indicate how many subtasks or tracks they completed during that time slot. As shown, in the illustrated example, employees 1 and 2 completed 3 subtasks and employee 3 completed 4 subtasks in the first time slot. In another embodiment, the workers are required to indicate how many subtasks or tracks they completed during that time slot.

At some point after each time slot, a supervisor or designate, completes the actual and variance columns 414,416.

As shown in the first time slot, a total of ten (10) tracks was completed. This is one more (+1) than planned and is so indicated in the variance column 416.

In the second time slot (8-9), employee 1 completed 3 tracks and employees 2 and 3 completed 4 tracks. Thus, a total of 11 tracks were completed in the second time slot and an accumulated total of completed tracks of 21 were completed in the first two time tracks. For the second time slot, this represented a variance of −1, for an accumulated variance of zero (0). This information is recorded on the board 400 for the remainder of the predetermined time period.

As indicated, each employees' performance over the course of the predetermined time period can be seen from a review of the board 400. Thus, as time progresses, a supervisor can review the board 400 and assess whether there are any problems of which the supervisor should be aware and appropriate action may be taken. For example, if the variance is a negative variance, the supervisor may be able to establish or identify and remove an obstacle to completing the task. Therefore, in one embodiment, action can be taken sooner, e.g., before the end of a workshift, thereby reducing the effect of the obstacle.

Returning to FIG. 1, in a sixth process block 112, a total variance for the predetermined period of time is recorded. In one embodiment, this is accomplished without reference to the workers. In the illustrated embodiment, after the shift is completed the total (accumulated) variance, i.e., “+3” over the eight (8) time slots is recorded.

As stated above, the variance between the actual number of subtasks completed and the target number in each time slot and the accumulated variance are temporarily recorded on the board 400 for the predetermined period of time. In one embodiment, the total variance is recorded in a log.

In one embodiment, the target number of subtasks to be completed during each time slot is modified as a function of the recorded total variances. For example, changes to processes or removal of obstacles from completing “tracks” (see below) may allow the total number of tracks which may be accomplished during a time slot to increase.

In one embodiment, the total variance for the predetermined period of time is recorded on a writeable medium, e.g., a log book or a piece of paper. In another embodiment, the writeable medium is a spreadsheet or other storage format stored on a computer.

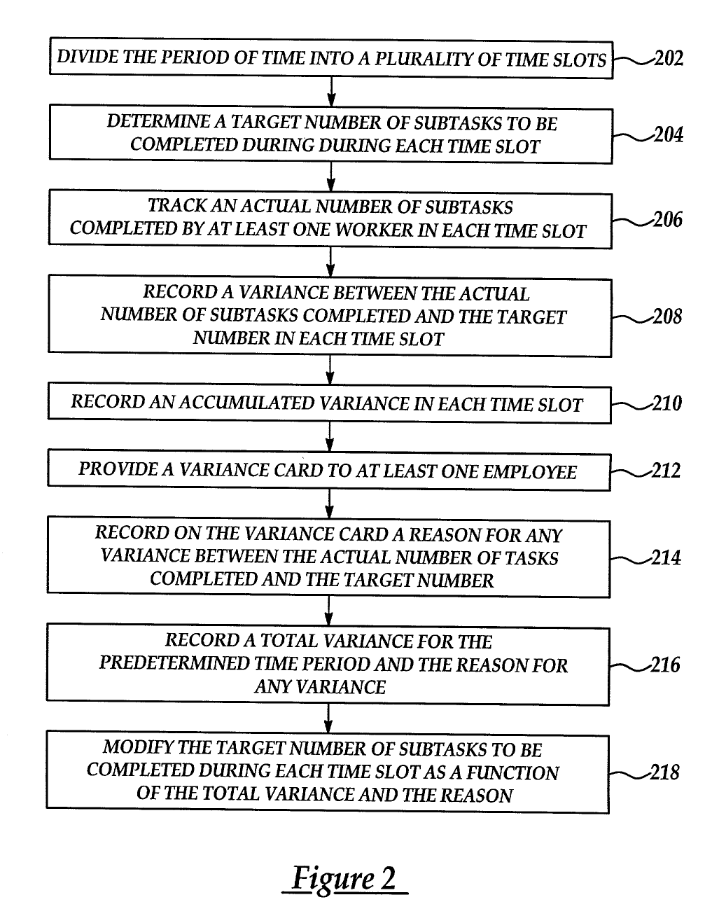

With reference to FIG. 2, a method 200 for tracking progress, by at least one worker, on a task over a predetermined period of time, according to another embodiment of the present invention will now be described. The task includes a plurality of subtask or tracks. In a seventh process block 202, the predetermined period of time is divided into a plurality of timeslots. In an eighth process block 204, a target number of subtasks to be completed during each timeslot is determined. In a ninth process block 206, an actual number of subtasks completed by at least one worker in each time slot is tracked. A variance between the actual number of subtasks completed and the target number is recorded for each time slot in a tenth process block 208.

In an eleventh process block 210, an accumulated variance in each time slot is recorded.

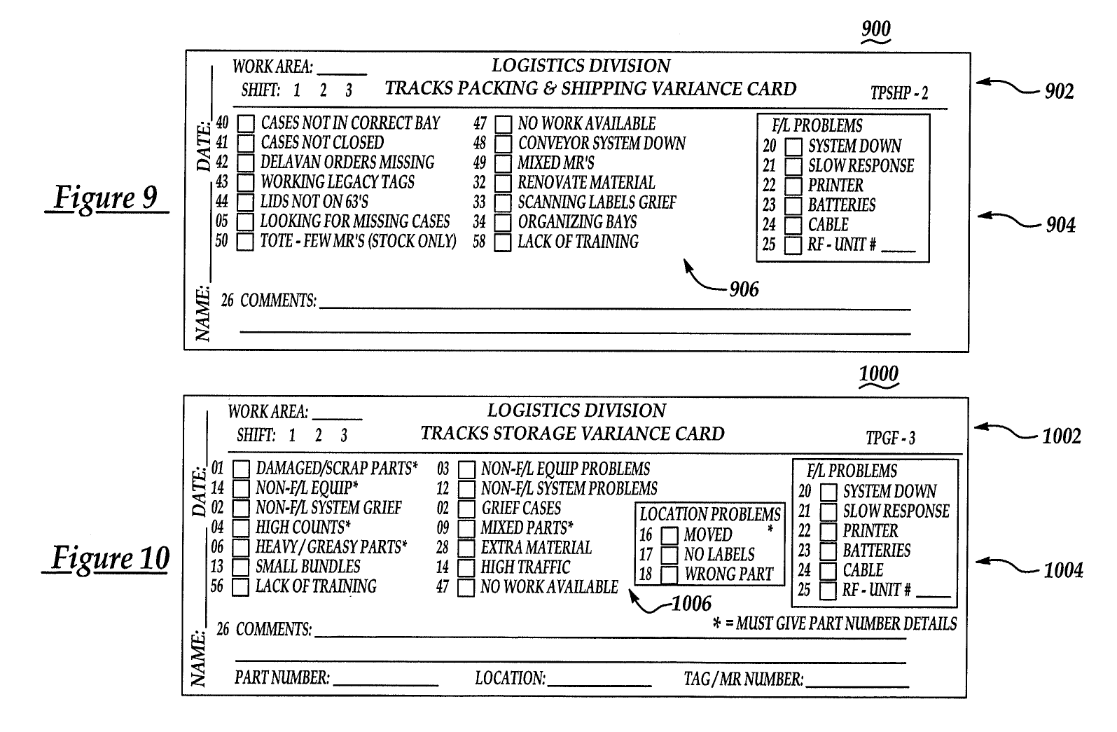

With reference to FIG. 2 and FIGS. 5-10, in a thirteenth process block 212, a variance card 500, 600, 700, 800, 900, 1000 is provided to the employees/workers. In a fourteenth process block 214, for any variance between the actual number of subtasks completed and the target number, a reason is recorded on the variance card 500, 600, 700, 800, 900, 1000. In one embodiment, the variance card 500, 600, 700, 800, 900, 1000 is filled out by the employee.

In one embodiment, a variance card 500, 600, 700, 800, 900, 1000 may be filled out for any variance, both positive and negative variances. In another embodiment, a variance card 500, 600, 700, 800, 900, 1000 must be filled out for any variance, both positive and negative variances A positive variance occurs when a worker completes more tasks than the target number for any time slot. A negative variance occurs when a work completes less tasks than the target number for any time slot. achieves more than the

The variance card 500, 600, 700, 800, 900, 1000 may vary based on the location, the type of work being tracked and the types of issues likely to be found at that location.

In one embodiment, the variance card 500, 600, 700, 800, 900, 1000 includes an identification information section 502, 602, 702, 802, 902, 1002 and a variance information section 504, 604, 704, 804, 904, 1004. The identification information section 502, 602, 702, 802, 902, 1002 includes locations for the employee to identify, e.g., their name, the date, and their shift.

The variance information section 504, 604, 704, 804, 904, 1004 includes a plurality of checkboxes 506, 606, 706, 806, 906, 1006 associated with the most common types of reasons which would cause a variance. Typically, these reasons are determined based on feedback from the employees performing the work.

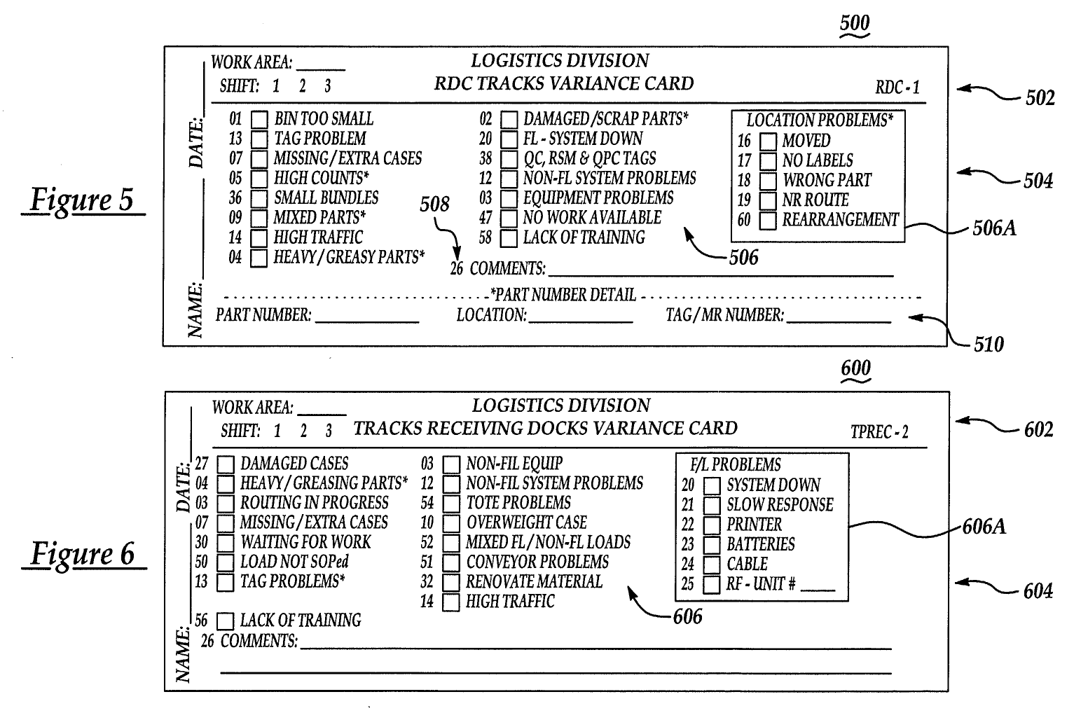

With particular reference to FIG. 5, the variance card 500 is adapted to be used in a particular warehousing environment. The variance information section 504 includes a plurality of checkboxes 506 associated with common reasons found at that location:

BIN TOO SMALL;

TAG PROBLEM;

MISSING/EXTRA CASES

HIGH COUNTS;

SMALL BUNDLES;

MIXED PARTS;

HIGH TRAFFIC;

HEAVY/GREASY PARTS;

DAMAGED/SCRAP PARTS;

FL-SYSTEM DOWN;

QC, RSM, & QPC TAGS;

NON-FL SYSTEM PROBLEMS;

EQUIPMENT PROBLEMS;

NO WORK AVAILABLE;

LACK OF TRAINING.

A subset of checkboxes 506A corresponding to related reasons may be grouped together, for example, reasons related to the location of material to be moved may be grouped together, as shown:

MOVED;

NO LABELS;

WRONG PART;

NR ROUTE; and,

REARRANGEMENT.

The variance information section 504 also includes a comments section 508. The comments section 508 may be used to describe anything not covered by the identified reasons, for example, the cause of a variance and/or a recommended solution.

As shown, the variance information section 504 also includes a parts location section 510 which includes entry locations for part number details which may be needed for some of the reasons.

With particular reference to FIG. 6, the variance card 600 is adapted for use in a receiving docks environment. The variance information section 602 includes the following predetermined common reasons for variances:

DAMAGED CASES;

HEAVY/GREASY PARTS;

ROUTING IN PROCESS;

MISSING/EXTRA CASES;

LOAD NOT SOP'ED;

TAG PROBLEMS;

LACK OF TRAINING;

NON-F/L EQUIP;

NON-F/L SYSTEM PROBLEMS;

TOTE PROBLEMS;

OVERWEIGHT CASE;

MIXED FL/NON-FL LOADS;

CONVEYOR PROBLEMS;

RENOVATE MATERIAL; and,

HIGH TRAFFIC.

Additionally, the variance information section 604 includes a subset of checkboxes 606A relating to a facility logistics (F/L) system which includes a plurality of electronic terminals for recording warehousing transactions. The subset of checkboxes includes the following F/L related reasons:

SYSTEM DOWN;

SLOW RESPONSE;

PRINTER;

BATTERIES;

CABLE; AND,

RF.

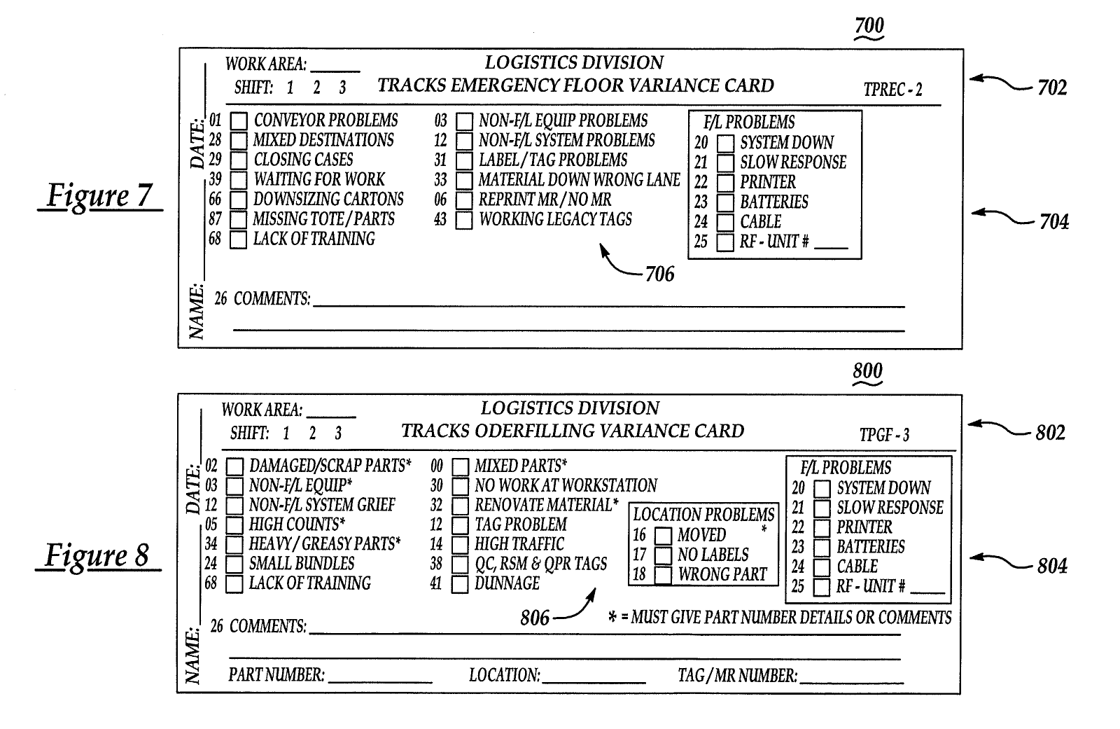

With particular reference to FIGS. 7-10, variance cards 700, 800, 900, 1000 for use in an warehouse emergency environment, an order filling environment, a packing and shipping environment, and a storage environment, respectively, are shown. The variance cards 700, 800, 900 may also include the shift which may be used to identify when and where variances (positive or negative) consistently occur.

These variance cards 700, 800, 900, 1000 are adapted to use in their respective environments and are used in a similar manner.

Returning to FIG. 2, in a fifteenth process block 216 a total variance for the predetermined period of time and the reason for any variance is recorded without reference to the at least one worker. For example, after the predetermined time period, the variance cards 500, 600, 700, 800, 900, 1000 filled out during the shift are gathered. The reasons for all the variances which are occurred during the predetermined time period are tabulated and record along with the total variance for the time period. In one embodiment, the total variance is recorded without reference to the workers.

In a sixteenth process block 218, the target number of subtasks to be completed during each time slot is modified as a function of the total variance and the reason.

In one embodiment, the variance between the actual number of subtasks completed and the target number in each time slot and the accumulated variance are temporarily recorded for the predetermined period of time. The total variance is recorded in a log. As discussed above, in one embodiment the log is a spreadsheet stored on a computer. The log may be stored indefinitely or deleted after a predetermined period of time, e.g., every month.

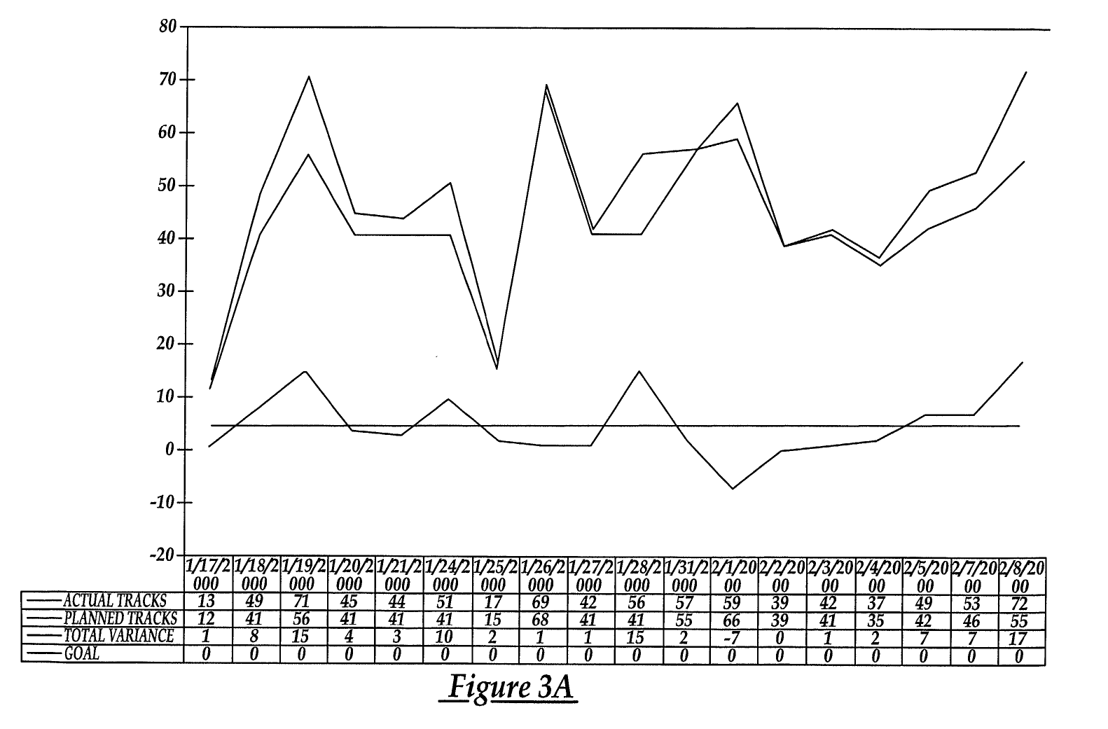

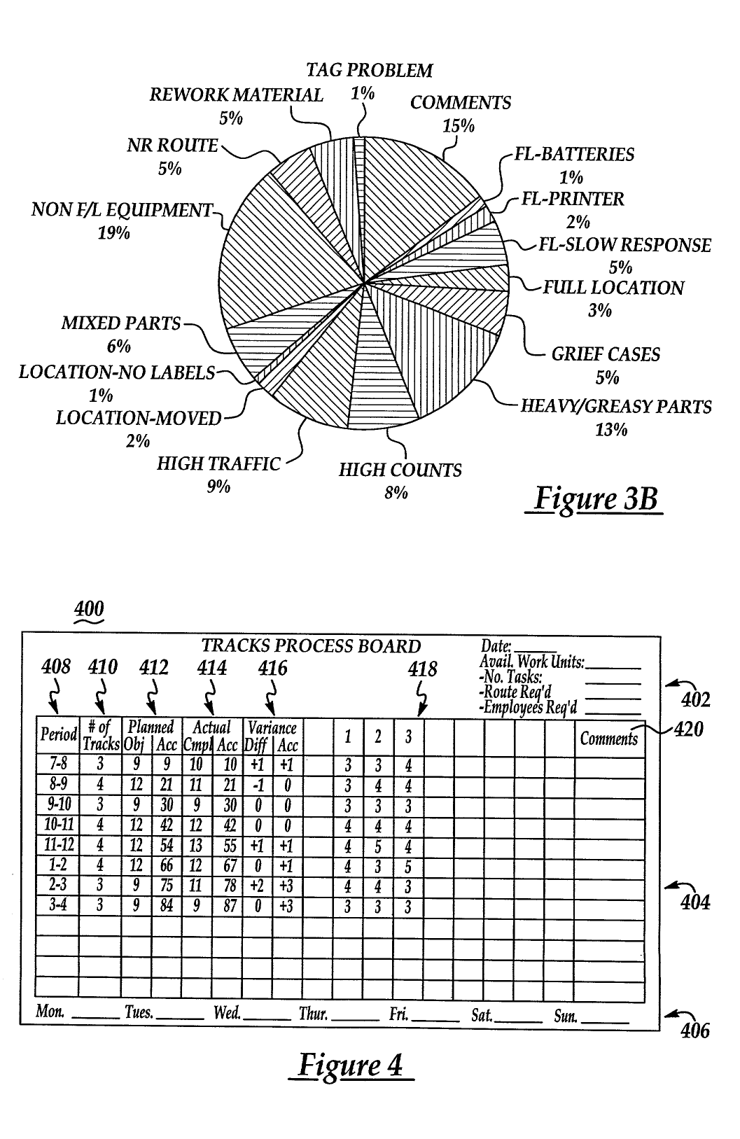

With reference to FIGS. 3A and 3B, the spreadsheet may be used to generate various chart and graphs to illustrate the trend of variances over time and/or the reasons for variances.

The process 100 also provides diagnostic/prognostic capabilities. For example, diagnostic analysis of the data captured by the process will indicate how well a supervisor did in dealing with a flexible work force. In other words, was the supervisor successful in shifting workers to other areas when work was slow or requesting additional workers when needed, e.g., in emergencies. The process 100 also tracks trends regarding track completion, e.g., whether the target numbers were met, variances, and work flow trends.

In one embodiment of the present invention, a method of tracking progress by at least one work, on a task over a period of time, the tasks including a plurality of subtasks, includes the steps of dividing the period of time into a plurality of timeslots, determining a target number of subtasks to be completed during each time slot, tracking an actual number of subtasks completed by the at least one worker in each time slot, recording a variance between the actual number of subtasks completed and the target number associated with each time slot; and taking at least one action in response to the variance.

In one embodiment, the action taken includes filling out a variance card, as described above. In another embodiment, one or more variances are analyzed to help determine what action may need to be taken. For example, the analysis may indicate recurring problems which need to be addressed in order to increase efficiency. For example, in one embodiment the pick path may be identified as causing delays in the parts being pulled. Therefore, a more efficient pick path may be determined to pick parts up. Alternatively, routing software may be incorporated to attempt to optimize the pick paths. In addition, if the pick path is causing delays, the analysis may reveal which parts are more efficiently grouped together. For example, perhaps parts are identified as commonly picked together. Then they may be located closely to each other to increase the efficiency of the system. In addition, as illustrated in FIGS. 5 and 6, if lack of training is identified as a repetitive problem then a process change may be to provide more training in identified areas. If heavy parts are a recurring problem, then a process change may include a better way to store, move heavy parts. In addition, heavy parts may be moved to a preferred height in the inventory bins in order to be easier to move etc. If tag problems are a recurring problem, then the process improvement may be to review tag labels and update any missing labels, or to identify a better way of placing tag labels so they are not lost.

### INDUSTRIAL APPLICABILITY

With reference to the Figs., the present invention provides a 100, 200 for tracking progress, by at least one worker, on a task over a predetermined period of time, e.g., an eight (8) shift. The predetermined time period is divided into time slots of one (1) hour. The task includes a plurality of subtasks. An example task is order filling. Each order is a subtask. Progress on the task is tracked using a board 400 (shown in FIG. 4). The board 400 includes a plurality of rows and columns. Each row corresponds to a timeslots. The columns are used to indicate target and actual goals towards a planned number of tracks per each time slot. The performance of each individual worker towards their goal is indicated on the board 400. Thus, a supervisor can review each individual's progress or performance during the day to detect any abnormalities or problems.

At various times during the shift, the supervisor or supervisor designate reviews the board 400 and writes in the variance for each time slots and the accumulated variance. In one embodiment, the variance must be written in the appropriate location for each time slot, before the next time slot is passed. For each variance (positive or negative), the worker is required to fill out a variance card 500, 600, 700, 800, 900, 1000.

At the end of the shift the supervisor or designate records the total variance from the board 400 and tabulates the reasons for any variances from the filled out variance cards 500, 600, 700, 800, 900, 1000 in a log. This is done without reference to the individual workers.

This data may be viewed and analyzed in order to detect any problems or issues related to performing the task. Additionally, the target number of tracks or subtasks to be performed each time slots may be modified. For example, the purpose of the tracking method is to identify problems or issues encountered in performing the task. Thus, if there are continually no variances or positive variances, then the target number may be raised. This ensures that the target number will not (always) be hit, i.e., there will be negative variances. Raising the target number will generally cause negative variances to occur, thereby highlighting potential inefficiencies, i.e., obstacles, in the process. As the inefficiencies are highlighted, addressed, and eliminated or reduced, the process continues to improve, and thereby, the overall productivity of the workers also improves.

Thus, variance cards will be filled. Additionally, since the variance card data is recorded without reference to the individual, the accuracy of the data is improved.

Other aspects and features of the present invention can be obtained from a study of the drawings, the disclosure, and the appended claims.

What is claimed is:

1. A method, for tracking progress, by at least one worker, on a task over a period of time, the task including a plurality of subtasks, comprising:
dividing the period of time into a plurality of timeslots;
determining a target number of subtasks to be completed during each timeslot;
tracking an actual number of subtasks completed by the at least one worker in each time slot;
recording a variance between the actual number of subtasks completed and the target number associated with each time slot;
recording an accumulated variance associated with each time slot; and,
recording a total variance for the predetermined period of time.

2. A method, as set forth in claim 1, wherein the period of time is predetermined.

3. A method, as set forth in claim 1, wherein the period of time varies.

4. A method, as set forth in claim 1, wherein the step of recording the total variance for the period of time is performed without reference to the workers.

5. A method, as set forth in claim 1, wherein the variance between the actual number of subtasks completed and the target number in each time slot and the accumulated variance are temporarily recorded for the period of time.

6. A method, as set forth in claim 5, wherein the total variance is recorded in a log.

7. A method, as set forth in claim 1, wherein a total variance for a plurality of periods of time are recorded.

8. A method, as set forth in claim 1, wherein the target number of subtasks to be completed during each time slot is modified as a function of the recorded total variances.

9. A method, as set forth in claim 1, wherein the timeslots are illustrated on a writeable medium.

10. A method, as set forth in claim 9, wherein the writeable medium includes locations for entry of the actual number of subtasks completed by each worker, the variance between the actual number and the target number, and the accumulated variance in each time slot.

11. A method, as set forth in claim 9, wherein the writeable medium is erasable.

12. A method, as set forth in claim 9, wherein the step of tracking an actual number of subtasks completed by each worker in each time slot is performed by the worker.

13. A method, as set forth in claim 9, wherein the writeable medium is a chalkboard.

14. A method, as set forth in claim 9, wherein the writeable medium is a white board.

15. A method, as set forth in claim 9, wherein the writeable medium is a piece of paper.

16. A method, as set forth in claim 1, wherein the total variance for the period of time is recorded on a writeable medium.

17. A method, as set forth in claim 16, wherein the writeable medium is a spreadsheet stored on a computer.

18. A method, as set forth in claim 16, wherein the writeable medium is a piece of paper.

19. A method, as set forth in claim 1, including the steps of:
providing a variance card to the at least one employee;
recording on the variance card a reason for any variance between the actual number of subtasks completed and the target number; and,
recording the reason with the total variance.

20. A method, as set forth in claim 19, wherein the total variance and the reason are recorded without reference to the worker.

21. A method, as set forth in claim 19, wherein the variance card includes a plurality of predetermined reasons which may be checked off.

22. A method, as set forth in claim 21, wherein the variance card includes a comments section.

23. A method, as set forth in claim 1, including the step of planning a number of workers for at least a portion of the period of time based on the number of work flow based on the target number.

24. A method, as set forth in claim 23, including the step of reallocating a worked based on the planned number of workers.

25. A method, as set forth in claim 1, including the step of providing diagnostics on the completion of the task.

26. A method for tracking progress, by at least one worker, on a task over a period of time, the task including a plurality of sub-subtasks, comprising:
dividing the period of time into a plurality of timeslots;
determining a target number of subtasks to be completed during each timeslot;
tracking an actual number of subtasks completed by the at least one worker associated with each time slot;
recording a variance between the actual number of subtasks completed and the target number associated with each time slot;
recording an accumulated variance associated each time slot;
recording a total variance for the period of time;
providing a variance card to the at least one worker;
recording a reason on the variance card for a variance between the actual number of subtasks completed and the target number;
recording a total variance for the period of time and the reason for the variance; and,
modifying the target number of subtasks to be completed during at least one time slot as a function of the total variance and the reason.

27. A method, as set forth in claim 26, wherein the period of time is predetermined.

28. A method, as set forth in claim 26, wherein the period of time varies.

29. A method, as set forth in claim 26, wherein the step of recording the total variance for the period of time is performed without reference to the workers.

30. A method, as set forth in claim 26, wherein the variance between the actual number of subtasks completed and the target number in each time slot and the accumulated variance are temporarily recorded for the predetermined period of time.

31. A method, as set forth in claim 26, wherein the total variance is recorded in a permanent log.

32. A method, as set forth in claim 26, wherein the timeslots are illustrated on a writeable medium.

33. A method, as set forth in claim 32, wherein the writeable medium includes locations for entry of the actual number of subtasks completed by each worker, the variance between the actual number and the target number, and the accumulated variance in each time slot.

34. A method, as set forth in claim 32, wherein the writeable medium is erasable.

35. A method, as set forth in claim 26, wherein the step of tracking an actual number of subtasks completed by each worker in each time slot is performed by the worker.

36. A method, as set forth in claim 32, wherein the writeable medium is a chalkboard.

37. A method, as set forth in claim 32, wherein the writeable medium is a white board.

38. A method, as set forth in claim 32, wherein the writeable medium is a piece of paper.

39. A method, as set forth in claim 26, wherein the total variance for the predetermined period of time is recorded on a writeable medium.

40. A method, as set forth in claim 39, wherein the writeable medium is a spreadsheet stored on a computer.

41. A method, as set forth in claim 39, wherein the writeable medium is a piece of paper.

42. A method, as set forth in claim 26, wherein the total variance and the reason are recorded without reference to the worker.

43. A method, as set forth in claim 26, wherein the variance card includes a plurality of predetermined reasons which may be checked off.

44. A method, as set forth in claim 26, wherein the variance card includes a comments section.

45. A method, as set forth in claim 26, including the step of planning a number of workers for at least a portion of the period of time based on the number of work flow based on the target number.

46. A method, as set forth in claim 45, including the step of reallocating a worked based on the planned number of workers.

47. A method, as set forth in claim 26, including the step of providing diagnostics on the completion of the task.

48. A method for tracking progress, by at least one worker, on a task over a predetermined period of time, the task including a plurality of sub-subtasks, comprising:
dividing the period of time into a plurality of timeslots;
determining a target number of subtasks to be completed during each timeslot;
tracking an actual number of subtasks completed by the at least one worker in each time slot;
temporarily recording a variance between the actual number of subtasks completed and the target number associated with each time slot;
temporarily recording an accumulated variance associated with each time slot;
providing a variance card to the at least one worker;
recording a reason on the variance card for a variance between the actual number of subtasks completed and the target number;
recording a total variance for the predetermined period of time and the reason for the variance in a log; and,
modifying the target number of subtasks to be completed during at least one time slot as a function of the total variance and the reason.

49. A method, as set forth in claim 48, wherein the step of recording a total variance is performed without reference to the at least one worker.

50. A method, for tracking progress, by at least one worker, on a task over a period of time, the task including a plurality of subtasks, comprising;
dividing the period of time into a plurality of timeslots;
determining a target number of subtasks to be completed during each timeslot;
tracking an actual number of subtasks completed by the at least one worker in each time slot;
recording a variance between the actual number of subtasks completed and the target number associated with in each time slot;
recording an accumulated variance associated with in each time slot; and,
taking at least one action in response to the variance.

51. A method, as set forth in claim 50, wherein said action includes the step of modifying at least one process in response to the variance.

52. A method, as set forth in claim 26, wherein the step of recording a total variance is performed without reference to the at least one worker.

53. A method, as set forth in claim 1, including the step of analyzing the variance.

54. A method, as set forth in claim 53, including the step of taking an action associated with the variance in response to the analysis.

55. A method, as set forth in claim 54, wherein the action includes changing at least one process associated with the task.
